(19) United States
(12) Patent Application Publication
(10) Pub. No.: US 2007/0267257 A1
(43) Pub. Date: Nov. 22, 2007

(54) Hybrid pads for disc brakes

(76) Inventor: Okamura Hiromasa, Mishima-shi (JP)

Correspondence Address: BUCHANAN, INGERSOLL & ROONEY PC, POST OFFICE BOX 1404, ALEXANDRIA, VA, 22313-1404, US

(21) Appl. No.: 11/798,854

(22) Filed: May 17, 2007

(30) Foreign Application Priority Data
May 18, 2006 (JP) 2006-138988
Dec. 5, 2006 (JP) 2006-328145
Feb. 19, 2007 (JP) 2007-037681

(51) Int. Cl. F16D 69/00

(52) U.S. Cl. 188/251 A

(57) ABSTRACT

A hybrid pad for a disc brake has first friction members and a second friction member. The first friction members can be positioned at a rotor rotation inlet portion and at a rotor rotation outlet portion of the pad. The second friction member can be positioned at a central portion of the pad. The first friction members include a Young's modulus E1, a friction coefficient μ1 and a sum of the sliding areas A1 of the paired first friction members to come into sliding contact with the disc rotor. The second friction member has a Young's modulus E2, a friction coefficient μ2 and a sliding area A2 to come into sliding contact with the disc rotor. The μ2 is higher than the μ1, the E2 is higher than the E1, and (E2×A2)/(E1×A1) is 0.8 or more and 1.2 or less.

This application claims priority to Japanese patent application serial number 2006-138988, 2006-328145, 2007-37681, the contents of which are incorporated herein by reference.

### BACKGROUND OF THE INVENTION

The present invention relates to hybrid pads for disc brakes, which include a plurality of friction members having different characteristics.

In the prior art, hybrid pads have been described in U.S. Pat. No. 4,926,978 ('978 Patent), JP-A-2004-125081 ('081 Patent), JP-A-2003-172385 ('385 Patent), JP-A-9-112606 ('606 Patent), and JP-A-2000-120738 ('738 Patent).

The hybrid pad, as described in the '978 Patent, has friction members of different degrees of hardness. The pad has a hard friction member at a central portion and soft friction members at the two side portions. This construction aims at suppressing an uneven wear of a disc rotor for the pad to come into sliding contact with.

The hybrid pad, as disclosed in 081 Patent, has a plurality of friction members with different Young's moduli and wearable properties. The pad has the friction member with high Young's modulus and easy wearable property at a rotation outlet portion, from which a disc rotor rotates out. This construction aims at making break noise smaller and making effective characteristics of the pad compatible.

The hybrid pad, as disclosed in 385 Patent, has a plurality of friction members with different friction characteristics. The pad is constructed to obtain the desired relations between a sliding rate and a friction coefficient by combining those friction members. This construction aims at suppressing the brake noise.

The hybrid pad, as disclosed in 606 Patent, has friction members of different friction coefficients. A height of the friction member with a lower friction coefficient is higher than a height of the friction member with a higher friction coefficient. This construction aims at making a break noise smaller and making effective characteristics of the pad compatible.

The hybrid pad, as disclosed in 738 Patent, has friction members of different hardness degrees. The pad has a harder friction member at a rotation outlet portion, from which the disc rotor rotates out. This construction aims at suppressing noise as well.

The hybrid pads, as disclosed in 081 Patent and 606 Patent, have the friction members of different heights. At a braking time, therefore, the higher friction member comes earlier into sliding contact with the disc rotor, and then the lower friction member comes into sliding contact with the disc rotor. In this case, it is not clear how the steps of the friction member change while the braking operations are being repeated, thereby leaving the effect of the stepped friction members indefinite.

Further, as described above, another hybrid pad of the prior art has a plurality of friction members of different materials, so that the wear of the individual friction members are different. As the wear advances, therefore, the heights of the individual friction members become different, thereby causing a problem of the brake feeling deteriorated.

Thus, there is need in the art for a hybrid pad which can make the break noise smaller and make the brake feeling characteristics properly compatible.

### SUMMARY OF THE INVENTION

One aspect of the present invention, a hybrid pad includes the first friction members formed of the first material and the second friction member of the second material. The friction members are individually disposed at a rotor rotation inlet portion of the pad and at a rotor rotation outlet portion of the pad. The second friction member is disposed at the central portion of the pad. Moreover, the first friction members and the second friction member are made to satisfy μ2>μ1, E2>E1, and 0.8≦(E2×A2)/(E1×A1)≦1.2.

This configuration makes it possible to reduce a brake noise while maintaining a good brake feeling. In a mechanism capable of reducing the brake noise properly, vibrations in the thickness direction appear in the disc rotor at a braking time, and the vibrations have a plurality of fixed nodes. Moreover, at least one fixed node is positioned substantially at the center of the pad. In this pad, the second friction member of high hardness and high μ is positioned at that fixed node. According to this pad, therefore, it is possible to obtain the sufficient frictional force while suppressing the occurrence of the brake noise.

One reason why brake feeling is properly obtained is a result of setting the first friction member and the second friction member to wear at approximately equal rates. This can be achieved by setting (E2×A2)/(E1×A1) to about 1 (0.8 to 1.2). As a result, the first friction members and the second friction member can maintain substantially equal heights to obtain the frictional force linearly so that the brake feeling is satisfactory. As will be shown later, these results have been verified via testing.

In another aspect of the present invention, the second friction member has a width, which can be positioned in an area within a center angle of 20° on the center of rotation of the disc rotor. Therefore, the second friction member of the high hardness and the high μ is positioned at the fixed node positioned generally at the center of the pad, and the width of the second friction member being positioned within the center angle of 20° contributes to holding the fixed node substantially in the center of the pad. According to this configuration, therefore, it is possible to obtain the sufficient frictional force while suppressing the occurrence of the brake noise.

In another aspect of the present invention, the second friction member has a width length of 30 mm in the longitudinal direction of the pad. Therefore, the second friction member of the high hardness and the high μ is positioned at the fixed node positioned generally at the center of the pad, and the width of the second friction member is set within 30 mm so as to push only in the vicinity of the fixed node. Therefore, it is possible to obtain the sufficient frictional force while suppressing the occurrence of the brake noise.

In another aspect of the present invention, the Young's modulus E2 of the second friction member is set two times or more as high as the Young's modulus E1 of the first friction members, preferably 2 to 4 times. According to this construction, it is possible to reduce the brake noise and obtain a sufficient brake feeling.

In another aspect of the present invention, the first friction member includes a sliding area at the rotor rotation inlet portion and at the rotor rotation outlet portion of the pad. The individual sliding areas can be 40 to 60% of A1. Therefore, the first friction member of the rotor rotation inlet portion and the first friction member of the rotor rotation outlet portion can have substantially equal sliding areas. As a result, the central portion of the second friction member can be positioned substantially at the center of the pad. As a result, the second friction member can be reliably positioned with respect to the fixed node of the vibrations of the disc rotor, which occurs at the substantially center position of the pad. Thus, it is possible to suppress the brake noise reliably.

In another aspect of the present invention, chamfered portions cut out obliquely of the thickness direction of the friction members can be omitted. As a result, the individual friction members can maintain the same sliding areas to contact with the disc rotor 6, independently of the wear. After the friction members were worn, therefore, it is possible to obtain the same braking force and brake feeling as before any wear. Moreover, it is possible to reduce the brake noise similar to before any wear.

### BRIEF DESCRIPTION OF THE DRAWINGS

FIG. 1 is a front view of a pad of the present invention;

FIG. 2 is a side view of the pad taken an arrow II in FIG. 1;

FIG. 3 is a front view of a disc rotor, a caliper and the pad;

FIG. 4 is a view showing a frame format of a vibration of the pad during a brake operating;

FIG. 5 is a front view of a pad of a second configuration of the present invention; and

FIG. 6 is a side view of the pad taken at arrow VI in FIG. 5.

### DETAILED DESCRIPTION OF THE INVENTION

Each of the additional features and teachings disclosed above and below may be utilized separately or in conjunction with other features and teachings to provide improved hybrid pads. Representative examples of the present invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful configurations of the present teachings.

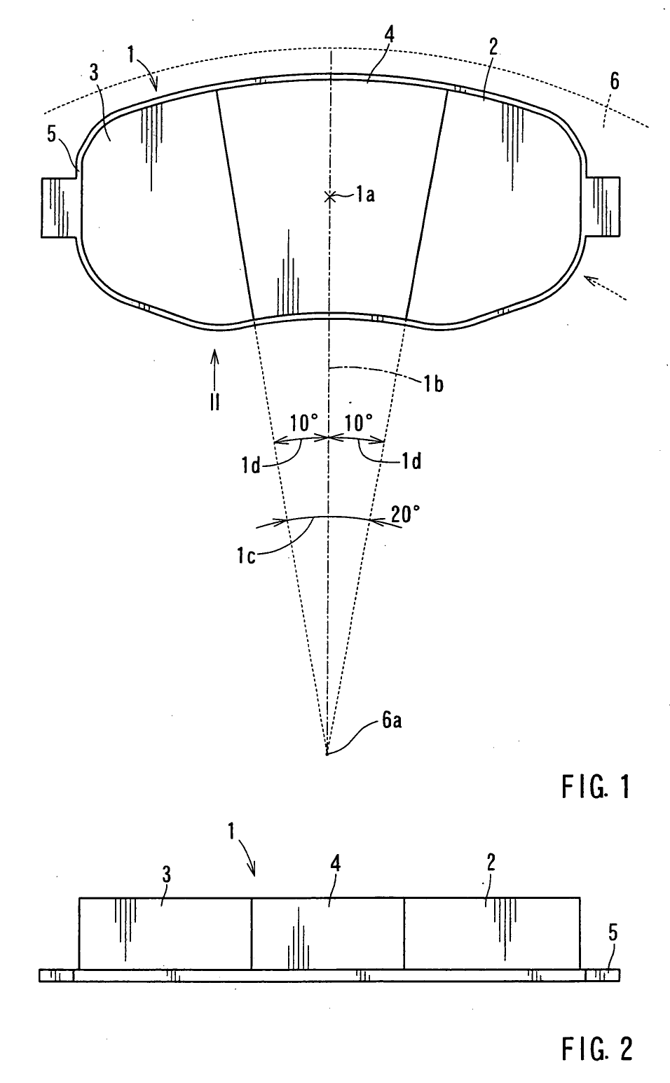

A pad 1, as shown in FIGS. 1 to 4, is a hybrid pad for a disc brake, and is integrally provided with a plurality of friction members 2 to 4 having different characteristics, and a back plate member 5. The friction members 2 and 3 are first friction members made of a first material, and the friction member 4 is a second friction member made of a second material.

The friction member 4 (also herein “the second friction member”) has a larger friction coefficient and a larger Young's modulus as compared to the friction members 2 and 3 (also herein “the first friction members”) in the following relation: μ1<μ2 and E1<E2.

In that relation, μ1 is the friction coefficient of the first friction member, μ2 is the friction coefficient of the second friction member, E1 is the Young's modulus of the first friction member, and E2 is the Young's modulus of the second friction member.

The friction member 2 of the first friction member is disposed at a rotor rotation inlet portion of the pad 1, to which a disc rotor 6 rotates in, as shown in FIG. 1. Friction member 3 is disposed at a rotor rotation outlet portion of the pad 1, from which the disc rotor 6 rotates out. The friction member 4 or the second friction member is disposed at a central portion between the rotor rotation inlet portion and the rotor rotation outlet portion. Therefore, the pad 1 is provided with the second friction member (or the friction member 4) having a high hardness and a high μ at its central portion, and the first friction members (or the friction members 2 and 3) having a low hardness and a low μ at its two ends.

As shown in FIGS. 1 and 2, the friction members 2 to 4 are supported on their backs by the back plate member 5, and are integrated through the back plate member 5. The back plate member 5 is made of a metal or a resin. The friction members 2 to 4 are substantially equal in height in the thickness direction, and can have a sliding face on its surface for the disc rotor 6. Moreover, the areas of the individual sliding faces can be configured so that the break noise may be suppressed and the brake feeling characteristics may be properly obtained or improved.

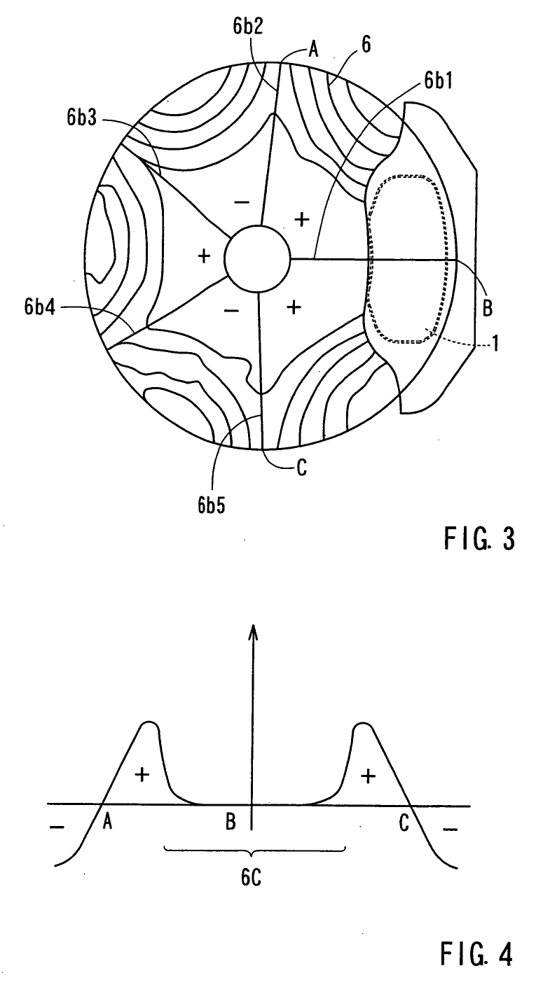

In order to suppress the break noise properly, the causes for the break noise are examined at first. One cause known for the break noise is known from the fact that the disc rotor 6 vibrates in the thickness direction at the time of braking. As the disc rotor 6 rotates vibration occurs, as shown in FIGS. 3 and 4, when the pad I is pushed in the thickness direction. For example, the disc rotor 6 vibrates in the +direction (to this side of the drawing) between points A and B and between points B and C, and in the −direction (to the deep side of the drawing) at the outer side portions of the point A and the point C. Then, a plurality of fixed nodes (spatially fixed nodes or vibration nodes) 6b1 to 6b5 having no vibration in the thickness direction appear in the disc rotor 6. These fixed nodes 6b1 to 6b5 appear at substantially fixed positions with respect to the pad 1, and one fixed node 6b1 consistently appears at a central position of the pad 1.

As shown in FIG. 3, a zero-vibration area 6c having a vibration displacement near zero appears (as referred to FIG. 4) in the vicinity of the fixed node 6b1. Moreover, the friction member 4 has a width length determined so that it may be positioned and confined in the zero-vibration area 6c. As shown in FIG. 1, for example, the width length of the friction member 4 is determined so that a center angle 1c (on a center of rotation 6a of the disc rotor 6) may be positioned within 20°. Preferably, the width length of the friction member 4 is determined so that a center angle 1d (across the transverse center line 1b of the pad 1) may be positioned within 10+, 8° and 6°. The center line 1b is obtained by joining the centroid 1a of the pad 1 and the rotation center 6a of the disc rotor 6.

Next, the brake feeling characteristics are noted. For brake feeling, it is preferred that the braking force is generated linearly according to the depressing force of the brake pedal. It is, therefore, preferred that the plural friction members 2 to 4 begin, at a braking time, to come into simultaneous sliding contact with the disc rotor 6, and that the contact state is kept even after the friction members 2 to 4 are worn out.

Therefore, the friction members 2 to 4 are required to have substantially equal wears, and the conditions for the equal wears were theoretically decided at first in the following manners. Assuming that the friction members 2 to 4 had an identical deflection ε, (Formula 1) was obtained from relational formulas between the stress and the deflection:

ε=F1/(A1·E1)=F2/(A2·E2) (Formula 1).

In Formula 1, F1 is the total load to be applied to the first friction members (or the friction members 2 and 3), A1 is the total sliding area of the first friction member (or the friction members 2 and 3), and E1 is the young's modulus of the first friction member (or the friction members 2 and 3).

Further, in Formula 1, F2 is a load to be applied to the second friction member (or the friction member 4), A2 is a sliding area of the second friction member (or the friction member 4), and E2 is the young's modulus of the second friction member (or the friction member 4).

F=F1+F2 (Formula 2).

In Formula 2, F is the total load to be applied to the friction members 2 to 4.

Formulas 3 to 5 were obtained from Formulas 1 and 2.

F1=F/(1+q) (Formula 3).

F2=F·q/(1+q) (Formula 4).

q=(E2/E1)·(A2/A1) (Formula 5).

It has been presented that the wear of the pad can be expressed by Formula 6 (as referred to Analysis and Countermeasures of Tribology, issued on May 31, 2005, p 441), and Formula 7 was obtained by differentiating the logarithm of Formula 6.

W=CP^{α}·V^{β}·T^{γ} (Formula 6).

In Formula 6, W is wear, P is pressure, V is an initial braking rate, and T is the temperature of friction on sliding face.

ΔW/W=αΔP/P+βΔV/V+γΔT/T (Formula 7).

In Formula 7, ΔV=0, ΔT=0 and ΔP/P=(F1−F2)/F. Further, Formula 8 can be obtained from Formulas 3 and 4.

ΔW/W=α·(1−q) (Formula 8).

In order to suppress the stepped wear between the friction members 2 to 4, the wears of the first friction member and the second friction member are equalized, thus ΔW=0 is sought to achieve that condition. Therefore, Formula 9 can be obtained from Formula 8, and Formula 10 can be obtained from the Formulas 5 and 9.

1−q=0 (Formula 9).

q=(E2×A2)/(E1×A)=1 (Formula 10).

By setting (E2×A2)/(E1×A1) to about 1, it can be theoretically estimated that the wear of the first friction member and the second friction member can be substantially equalized. It has been found preferable that the value q equal to or greater than 0.8 and equal to or less than 1.2, and preferably equal to or greater than 0.9 and equal to or less than 1.1.

Here, the Young's modulus E2 of the second friction member (or the friction member 4) is 2 times , preferably 2 to 4 times, as high as the Young's modulus E1 of the first friction member (or the friction members 2 and 3). For the friction members 2 and 3, it is preferred that the sum of the sliding area is A1, and that the individual sliding areas are substantially equal to 40 to 60% of A1. Moreover, the friction members 2 and 4 and the friction members 3 and 4 are at the adjoining positions, and the friction member 2 and the friction member 3 have bilaterally symmetric shapes.

A plurality of pads 1 (A to D) thus formed were prepared for the experiments, the results of which are tabulated in Table 1.

TABLE 1

Pad

| | A | B | C | D |
|---|---|---|---|---|
| E1 (MPa) | 121 | 136 | 164 | 200 |
| E2 (MPa) | 486 | 543 | 557 | 600 |
| E2/E1 | 4.0 | 4.0 | 3.4 | 3.0 |
| (E2 · A2)/(E1 · A1) | 1.14 | 1.14 | 0.97 | 0.86 |
| Brake feeling | Good | Good | Good | Good |
| Creep grown | Small | Small | Small | Small |

The aforementioned pads A to D used the second friction member 4 having a longitudinal width of 25 mm and a friction coefficient of 0.5. The first friction members 2 and 3 had the sum A1 of the sliding areas, which was 3.5 times as large as that of the second friction member. Further, first friction members 2 and 3 had a friction coefficient of 0.4, and were bilaterally symmetric with substantially equal sliding areas.

As a result of the experiments, it has been found that the wears of the individual friction members 2 to 4 of the pads A to D were substantially equal, that stepped wear did not occur, and that the brake feeling was satisfactory. It can be confirmed from the experimental results that any noise was sufficient small at the time of braking for the forward and backward runs. It can also be confirmed from the experimental results that the brake noise, as caused at a creep grown (e.g., when the brake is released on a slope in an automatic car) could be sufficiently reduced. The second friction member 4 of the aforementioned pads A to D had a width of 25 mm, but was replaced by a pad having the second friction member having a width of a center angle of 18°. Other characteristics of those pads were prepared similar to the aforementioned pads A to D. The results of the experiments of the pads were similar to those of the pads A to D.

Here, the synthetic friction coefficient μm of the friction members 2 to 4 can be obtained by Formula 11.

μm=(μ1+q·μ2)/(1+q) (Formula 11).

In Formula 11, μ1 is a friction coefficient of the first friction member (or the friction members 2 and 3), and μ2 is a friction coefficient of the second friction member (or the friction member 4).

In the case of q=1, the coefficient can be determined, in Formula 12.

μm=(μ1+μ2)/2 (Formula 12).

Thus, the pad 1 is formed. Specifically, as shown in FIG. 1, the pad 1 includes the first friction members formed of the first material and the second friction member of the second material. The friction members (or the friction members 2 and 3) are individually disposed at the rotation inlet portion of the pad and at the rotation outlet portion of the pad. The second friction member (or the friction member 4) is disposed at the central portion of the pad. Moreover, the first friction members and the second friction member are made to satisfy μ2>∥1, E2>E1, and 0.8≦(E2×A2)/(E1×A1)≦1.2.

According to this embodiment, therefore, it is possible to reduce the brake noise and obtain the good brake feeling. In the mechanism capable of reducing the brake noise properly, as shown in FIG. 3, the vibrations in the thickness direction appear in the disc rotor 6 at the braking time, and the vibrations have the plural fixed nodes 6b1 to 6b5. Moreover, one fixed node (6b1) consistently appears substantially at the center of the pad 1. In this embodiment, the second friction member (or the friction member 4) of the high hardness and the high μ is positioned at that fixed node 6b1. According to this embodiment, therefore, it is possible to obtain the sufficient frictional force while suppressing the occurrence of the brake noise.

The reason why the brake feeling is properly obtained is that the first friction members (or the friction members 2 and 3) and the second friction member (or the friction member 4) are set to the substantially equal wear by setting (E2×A2)/(E1×A1) to about 1 (0.8 to 1.2). As a result, the first friction members (or the friction members 2 and 3) and the second friction member (or the friction member 4) can take substantially equal heights to obtain the frictional force linearly so that the brake feeling is satisfactory. The aforementioned relative formulas were created from theoretical formulas. As illustrated herein, each was verified via results.

Moreover, the second friction member (or the second friction member 4) has the width, which is positioned in the area within the center angle of 20° on the center of rotation of the disc rotor 6, as shown in FIG. 1. As shown in FIG. 3, therefore, the second friction member of the high hardness and the high μ is positioned at the fixed node 6b1 which consistently appears substantially at the center of the pad 1, and the width of the second friction member is so positioned within the center angle of 20° as to hold only the vicinity of the fixed node 6b1. According to this embodiment, therefore, it is possible to obtain sufficient frictional force while suppressing the occurrence of the brake noise.

On the other hand, the Young's modulus E2 of the second friction member (or the friction member 4) is set two times or more as high as the Young's modulus E1 of the first friction members (or the friction members 2 and 3), preferably 2 to 4 times as high. According to this construction, it is possible to reduce the brake noise and obtain the sufficient brake feeling.

Each of the first friction members (or the friction members 2 and 3) at the rotation inlet portion and at the rotation outlet portion has a sliding area. And the individual sliding areas are 40 to 60% of A1. Therefore, the first friction member (or the friction member 2) of the rotation inlet portion and the first friction member (or the friction member 3) of the rotation outlet portion have the substantially equal sliding areas. As a result, the second friction member (or the friction member 4) can be positioned substantially at a center of the pad 1. As a result, the second friction member (or the friction member 4) can be reliably positioned with respect to the fixed node 6b1 of the vibrations of the disc rotor 6, which occurs substantially at a center position of the pad 1. Thus, it is possible to suppress the brake noise reliably.

Moreover, chamfered portions (as can be cut out obliquely of the thickness direction) are omitted from the individual friction members 2 to 4, as shown in FIG. 2. As a result, the individual friction members 2 to 4 can maintain the same sliding areas to contact with the disc rotor 6, independently of wear. After the friction members are worn, therefore, it is possible to obtain similar braking force and brake feeling as before any wear. Moreover, it is possible to reduce the brake noise similar to before any wear.

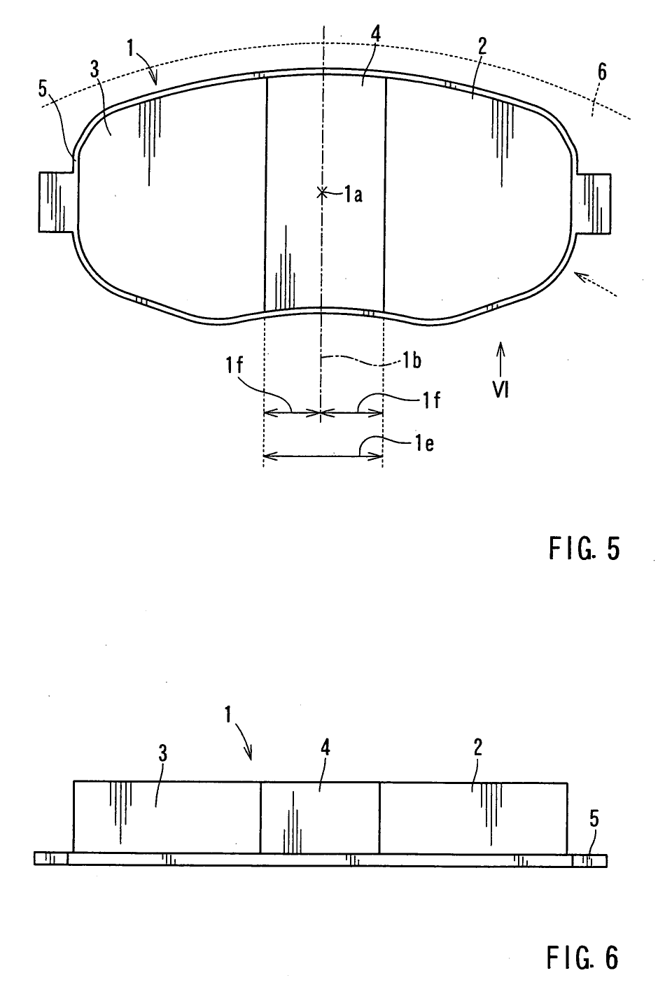

Another configuration according to the present invention will be described in reference to FIGS. 5 and 6. This configuration is formed substantially like the pad 1 shown in FIGS. 1 to 4, but the friction members 2 to 4 have slightly different shapes. The pad 1 shown in FIGS. 5 and 6 is described, as follows, centering the differences from the aforementioned configuration.

The friction member 4 (or the second friction member) is set to have a width length 1e of 30 mm or less in the pad longitudinal direction, as shown in FIG. 5. The length is preferably set within 20 mm. As a result, the friction member 4 of high hardness and high μ has a width length within the zero-vibration area 6c or the area near the fixed node 6b1 shown in FIG. 4. Preferably, the width length 1f across the transverse center line 1b of the pad 1 can be 15 mm or less, preferably 10 mm or less.

Moreover, the construction can be made such that μ2>μ1, E2>E1, and 0.8≦(E2×A2)/(E1×A1)≦1.2.

According to this configuration, therefore, it is possible to reduce the brake noise and obtain good brake feeling. The reason why the brake noise can be properly reduced is that the second friction member (or the friction member 4) of the high hardness and the high μ is positioned at the fixed node 6b1 (as referred to FIG. 3) of the vibrations of the disc rotor 6. According to this configuration, therefore, it is possible to obtain the sufficient frictional force while suppressing the occurrence of the brake noise.

Moreover, the reason why the brake feeling is properly obtained is that the first friction members (or the friction members 2 and 3) and the second friction member (or the friction member 4) are set to wear in a substantially equal fashion.

Moreover, the second friction member (or the friction member 4) has the width length of 30 mm in the longitudinal direction of the pad 1, as shown in FIG. 5. As shown in FIG. 3, therefore, the second friction member of the high hardness and the high μ is positioned at the fixed node 6b1 which consistently appears substantially at the center of the pad, and the width of the second friction member is set within 30 mm so as to push only in the vicinity of the fixed node 6b1. According to this configuration, therefore, it is possible to obtain the sufficient frictional force while suppressing the occurrence of the brake noise.

While the invention has been described with reference to specific configurations, it will be apparent to those skilled in the art that many alternatives, modifications and variations may be made. Accordingly, the present invention is intended to embrace all such alternatives, modifications and variations that may fall within the spirit and scope of the appended claims. For example, the present invention should not be limited to the representative configurations, but may be modified as described below.

For example, the friction member 4 according to the aforementioned configurations has the left and right end faces (or the boundary lines) formed straight, as shown in FIGS. 1 and 5. However the friction member 4 should not be limited to the straight shape but may also be modified into a polygonal straight shape or a curved shape.

The friction members 2 and 3 according to the aforementioned configurations have bilaterally symmetric shape, but may be modified into another shape. Moreover, the friction members 2 and 3 are preferably set to have substantially equal sliding areas, but may be modified to have different sliding areas.

The friction members 2 to 4 according to the aforementioned configurations are not spaced from each other (i.e. no groove in the thickness direction). However a space may be provided between the friction members.

This invention claims:

1. A hybrid pad for a disc brake comprising:
first friction members formed of a first material, the first friction members are disposed individually at a rotor rotation inlet portion, and at a rotor rotation outlet portion; and
a second friction member formed of a second material, the second friction member disposed at a central portion between the rotor rotation inlet portion and the rotor rotation outlet portion,
wherein μ2>μ1, E2>E1, and 0.8≦(E2×A2)/(E1×A1)≦1.2,
further wherein a Young's modulus of the first friction member is E1, a sum of the sliding areas of the first friction members able to come into sliding contact with the disc rotor is A1, a friction coefficient of the first friction members is μ1, a Young's modulus of the second friction member is E2, a sliding area of the second friction member able to come into sliding contact with the disc rotor is A2, and a friction coefficient of the second friction member is μ2.

2. The hybrid pad as in claim 1, wherein the second friction member has a width positioned in an area within a center angle of 20° on a center of rotation of the disc rotor.

3. The hybrid pad as in claim 1, wherein the second friction member has a width of 30 mm or less in a pad longitudinal direction.

4. The hybrid pad as in claim 1, wherein the Young's modulus E2 of the second friction member is set two times or more as high as the Young's modulus E1 of the first friction members.

5. The hybrid pad as in claim 1, wherein each of the first friction members at the rotor rotation inlet portion and at the rotor rotation outlet portion comprises a sliding area, further wherein the each sliding area is set to be 40 to 60% of A1.

6. The hybrid pad as in claim 5, wherein chamfered portions cut out obliquely in a thickness direction are omitted in the first friction members and the second friction member.

7. The hybrid pad as in claim 1, wherein the Young's modulus E2 of the second friction member is 2 to 4 times as high as the Young's modulus E1 of the first friction members.

8. A hybrid pad for a disc brake comprising:
first friction members including a first material, the first friction members respectively positioned at a rotor rotation inlet portion, and at a rotor rotation outlet portion; and
a second friction member including a second material, the second friction member positioned between the rotor rotation inlet portion and the rotor rotation outlet portion,
wherein μ2>μ1, E2≧2E1, and 0.8≦(E2×A2)/(E1×A1)≦1.2,
further wherein a Young's modulus of the first friction member is E1, a sum of the sliding areas of the first friction members able to come into sliding contact with the disc rotor is A1, a friction coefficient of the first friction members is μ1, a Young's modulus of the second friction member is E2, a sliding area of the second friction member able to come into sliding contact with the disc rotor is A2, and a friction coefficient of the second friction member is μ2.

9. The hybrid pad as in claim 8, wherein the second friction member has a width positioned in an area within a center angle of 20° on a center of rotation of the disc rotor.

10. The hybrid pad as in claim 8, wherein the second friction member has a width of 30 mm or less in a pad longitudinal direction.

11. The hybrid pad as in claim 8, wherein each of the first friction members at the rotor rotation inlet portion and at the rotor rotation outlet portion comprises a sliding area, further wherein each sliding area is set to be 40 to 60% of A1.

12. The hybrid pad as in claim 11, wherein chamfered portions cut out obliquely in a thickness direction are omitted in the first friction members and the second friction member.
